(19) United States
(12) Patent Application Publication
(10) Pub. No.: US 2025/0389268 A1
(43) Pub. Date: Dec. 25, 2025

(54) NORMAL LOAD TESTING DEVICE FOR PUMP BODY AND METHOD THEREOF

(71) Applicant: ZHEJIANG UNIVERSITY OF WATER RESOUREES AND ELECTRIC POWER, HANGZHOU (CN)

(72) Inventors: YAN FENG, HANGZHOU (CN); PENG YANG, HANGZHOU (CN)

(21) Appl. No.: 18/979,664

(22) Filed: Dec. 13, 2024

(30) Foreign Application Priority Data
Jun. 21, 2024 (CN) 202410808471.9

(51) Int. Cl. F04B 51/00; G01N 3/34

(52) U.S. Cl. CPC F04B 51/00; G01N 3/34; G01N 2203/0039

(57) ABSTRACT

The present disclosure discloses a normal load testing device for a pump body, which includes a fixed platform. A rotating mechanism is provided on the fixed platform, a rotating end of the rotating mechanism is connected to a fixed plate. The normal load testing device further includes: a plurality of connecting heating rings configured to connect the pump body to the fixed plate and heat the pump body; a stabilizing mechanism, configured to strengthen the stability of the pump body and the fixed plate after connection; a sensor, configured to collect test data of the pump body during the test; and a hammering mechanism, configured to excite the pump body from top to bottom. The normal load testing device can simulate the connection form between the pump body and an end cover, and can test a plurality of pump bodies at the same time, thus saving the test time.

### TECHNICAL FIELD

The present disclosure relates to a normal load testing device for a pump body and a method thereof, and belongs to the technical field of testing devices.

### BACKGROUND

A normal load is a force which acts on a surface of an object and is perpendicular to the surface. In mechanical design and analysis, the normal load is mainly caused by contact between components or externally applied forces. The normal load is related to a normal force on the contact surface, which is usually used to analyze the contact stress, the friction and the contact deformation. The normal load is closely related to the temperature of the material. If the influence of different temperatures on the normal load is not well understood, mechanical products will be influenced. However, in the prior art, it is difficult to simulate the connection form between the pump body and the end cover, and the number of pump bodies in a single test is small, which increases the test time.

### SUMMARY

The present disclosure aims to provide a normal load testing device for a pump body and a method thereof. The normal load testing device can simulate the connection form between the pump body and an end cover, and can test a plurality of pump bodies at the same time, thus saving the test time.

The technical scheme of the present disclosure is as follows. A normal load testing device for a pump body is provided, which includes a fixed platform, where a rotating mechanism is provided on the fixed platform, a rotating end of the rotating mechanism is connected to a fixed plate, and a plurality of internal threaded studs are distributed circumferentially below the pump body. The normal load testing device further includes:
a plurality of connecting heating rings, provided on the fixed plate, where the connecting heating ring is provided with through holes corresponding to the internal threaded studs, the through holes penetrate through a lower end surface of the fixed plate, and the connecting heating ring is configured to connect the pump body to the fixed plate and heat the pump body;
a stabilizing mechanism, provided on the fixed plate and located at a side of the connecting heating rings, wherein the stabilizing mechanism is configured to strengthen the stability of the pump body and the fixed plate after connection;
a sensor, provided at an end of the stabilizing mechanism in contact with the pump body, where the sensor is configured to collect test data of the pump body during the test; and
a hammering mechanism, provided on the fixed platform and located at an upper end of the pump body, where the hammering mechanism is configured to excite the pump body from top to bottom.

According to the normal load testing device for a pump body described above, a raised ring is provided at a lower end of the pump body; the connecting heating ring includes a first raised part protruding into the pump body; a recessed part is provided outside the first raised part, and is fitted with the raised ring; and a second raised part is provided outside the recessed part, and surrounds the outside of the raised ring.

According to the normal load testing device for a pump body described above, the rotating mechanism includes rotating seats provided at both sides of the fixed platform, respectively, a rotating disc is rotatably connected to an inner side of the rotating seat, a connecting block is provided on the rotating disc, and the connecting block is connected to the fixed plate.

According to the normal load testing device for a pump body described above, a motor is provided at an outer side of the rotating seat at one side, an output end of the motor is connected to the rotating disc at the same side; an L-shaped block is fixedly connected to an outer side of the rotating seat at the other side, a slot is provided in a horizontal part of the L-shaped block; the rotating disc is connected to a rotating shaft located below the L-shaped block, and the rotating shaft is provided with a plurality of threaded holes.

According to the normal load testing device for a pump body described above, the stabilizing mechanism includes a plurality of mounting seats provided at the side of the connecting heating rings, a first cylinder is provided in the mounting seat, a protruding end of the first cylinder is connected to a pressing block, and the sensor is provided on a lower end surface of the pressing block.

According to the normal load testing device for a pump body described above, the hammering mechanism includes a mounting plate, a second cylinder is fixedly connected to an upper end of the mounting plate, a protruding end of the second cylinder is connected to a movable block, the mounting plate is provided with a guide rail located at a lower end of the second cylinder, and the guide rail is in sliding connection with the movable block.

According to the normal load testing device for a pump body described above, a first guide rod is provided in the movable block, and protrudes from a lower end of the movable block; a lower end of the first guide rod is in sliding connection with a second guide rod, a lower end of the second guide rod is connected to a hammering plate; a spring surrounds the outside of the first guide rod, one end of the spring is fixedly connected to the second guide rod, and the other end of the spring is fixedly connected to the movable block.

A testing method of the normal load testing device for a pump body is provided. According to the method, an internal threaded stud of the pump body is aligned with a through hole of a connecting heating ring, and a rotating mechanism causes a fixed plate to be rotated, such that a screw is penetrated through and screwed into the internal threaded stud from the through hole penetrating a lower end surface of the fixed plate conveniently, and after a preset tightening torque is applied to the screw, a connection form between the pump body and an end cover is simulated; the rotating mechanism causes the fixed plate to rotate back to a horizontal state, the stabilizing mechanism operates to strengthen the pump body and brings a sensor in close proximity to the pump body; and a hammering mechanism then hammers an upper end surface of the pump body, and the sensor collects an excitation frequency generated in the hammering process.

According to the testing method of the normal load testing device for a pump body described above, under a same pre-tightening force of screws and a same hammering torque of hammering mechanisms, heating temperatures of the connecting heating rings are controlled to be different for pump bodies, so as to measure the change of the normal loads of the pump bodies at different temperatures.

According to the testing method of the normal load testing device for a pump body described above, under the same pre-tightening force of the screws and a same heating temperature of the connecting heating rings, hammering mechanisms are controlled to apply different hammering torques to the pump bodies, so as to measure the change of the normal loads of the pump bodies under different hammering torques.

Compared with the prior art, the present disclosure has the following beneficial effects.
1. According to the present disclosure, an internal threaded stud of a pump body is aligned with a through hole of a connecting heating ring. A rotating mechanism causes a fixed plate to be rotated, such that a screw is penetrated through and screwed into the internal threaded stud from the through hole penetrating a lower end surface of the fixed plate conveniently. After a preset tightening torque is applied to the screw, a connection form between the pump body and the end cover is simulated. The connecting heating ring is then used to heat the inside and the outside of the pump body simultaneously, such that various temperature ranges required by the test can be conveniently obtained. Finally, the pump body is hammered from top to bottom by a hammering mechanism. The vibration mode and the vibration frequency formed due to hammering are acquired by the sensor. Modal parameters such as the vibration mode and the inherent frequency of the test are obtained in a stable band, and then are analyzed.
2. The hammering mechanism of the present disclosure causes the movable block to move downwards by means of the second cylinder. The movable block drives the hammering plate to hammer the upper end surface of the pump body through the first guide rod and the second guide rod, so as to achieve the excitation effect. The spring is configured to control the hammering force, so as not to cause damage to the pump body.

### BRIEF DESCRIPTION OF DRAWINGS

FIG. 1 is a schematic structural diagram of the present disclosure;

FIG. 2 is a schematic structural diagram of a fixed plate;

FIG. 3 is a schematic structural diagram of a hammering mechanism;

FIG. 4 is a schematic structural diagram of a rotating shaft; and

FIG. 5 is a schematic structural diagram of a pump body tested.

The reference numerals: 1—fixed platform, 2—rotating mechanism, 3—fixed plate, 4—connecting heating ring, 5—stabilizing mechanism, 6—sensor, 7—hammering mechanism, 8—pump body, 21—rotating seat, 22—rotating disc, 23—connecting block, 24—motor, 25—L-shaped block, 26—slot, 27—rotating shaft, 28—threaded hole, 41—first raised part, 42—recessed part, 43—second raised part, 44—through hole, 51—mounting base, 52—first cylinder, 53—pressing block, 71—mounting plate, 72—second cylinder, 73—movable block, 74—guide rail, 75—first guide rod, 76—second guide rod, 77—hammering plate, 78—spring, 81—raised ring, 82—internal threaded stud.

### DETAILED DESCRIPTION

The present disclosure is further described with reference to the accompanying drawings and embodiments, which are not intended to limit the present disclosure.

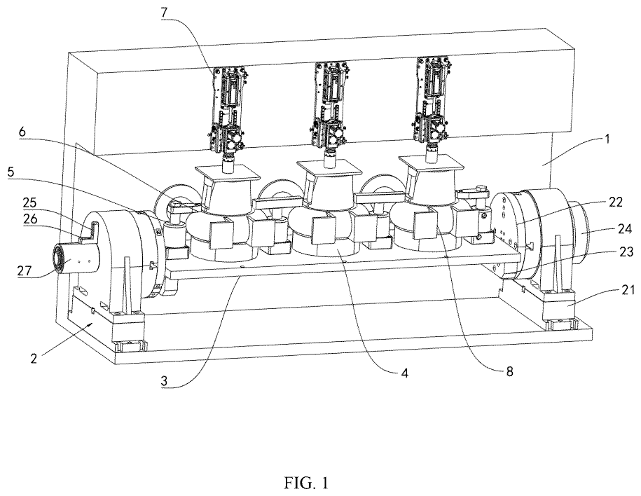

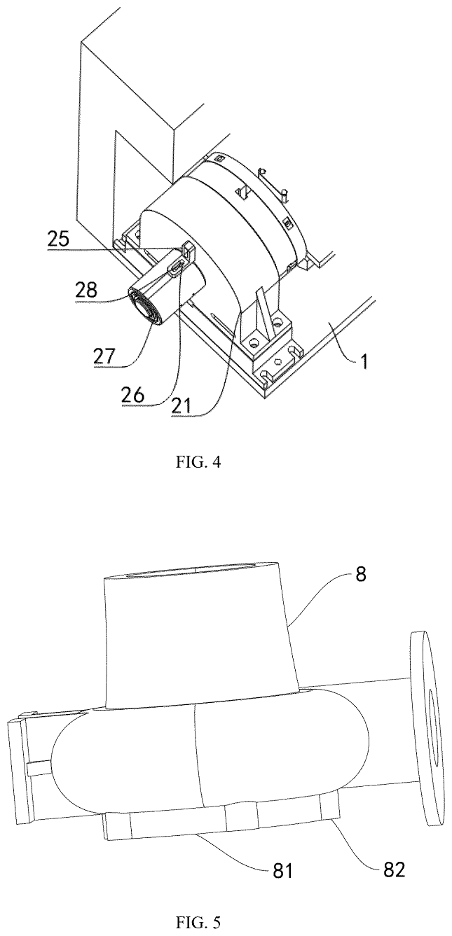

Embodiments: referring to FIGS. 1 to 4, a normal load testing device for a pump body includes: a fixed platform 1. A rotating mechanism 2 is provided on the fixed platform 1, as shown in FIG. 1 and FIG. 4. The rotating mechanism 2 includes rotating seats 21 provided at both sides of the fixed platform 1, respectively. A rotating disc 22 is rotatably connected to an inner side of the rotating seat 21. A connecting block 23 is provided on the rotating disc 22, and the connecting block 23 is connected to the fixed plate 3. A motor 24 is provided at an outer side of the rotating seat 21 at one side, and an output end of the motor 24 is connected to the rotating disc 22 at the same side. An L-shaped block 25 is fixedly connected to an outer side of the rotating seat 21 at the other side. A slot 26 is provided in a horizontal part of the L-shaped block 25. The rotating disc 22 is connected to a rotating shaft 27 located below the L-shaped block 25. The rotating shaft 27 is provided with two threaded holes 28. The rotating disc is rotated by the motor 24, such that the fixed plate 3 can be turned over, to facilitate screwing of a screw into an internal threaded stud 82. After the fixed plate 3 is rotated to a horizontal state, a bolt is penetrated through and screwed into the threaded hole 28 from above the slot 26 of the L-shaped block 25, such that the rotating shaft 27 cannot be rotated, thus further fixing the fixed plate 3 and preventing the fixed plate 3 from deflecting during the test. The connecting block 23 is connected to the fixed plate 3. Four M20 internal threaded studs 82 are distributed circumferentially below the pump body 8, and the pump body 8 is made of ductile iron. The normal load testing device further includes: a connecting heating ring 4, a stabilizing mechanism 5, a sensor 6, and a hammering mechanism 7.

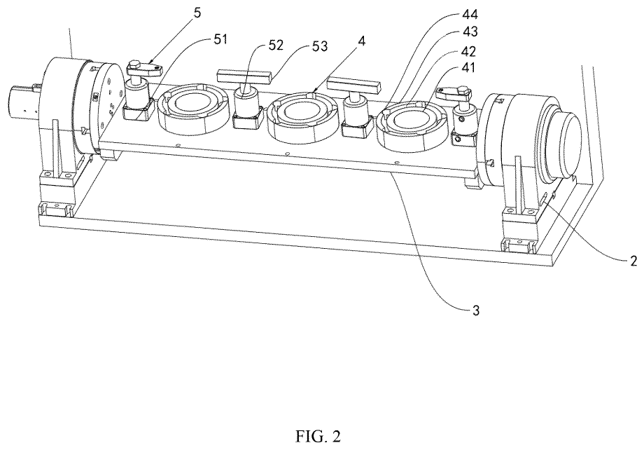

As shown in FIG. 2, three connecting heating rings 4 are provided on the fixed plate 3. The connecting heating ring 4 is provided with through holes 44 corresponding to the internal threaded studs 82. The through holes 44 penetrate through a lower end surface of the fixed plate 3. Four M20 screws are penetrated through a lower end surface of the fixed plate 3 and screwed into the internal threaded studs 82, to connect the pump body 8 to the fixed plate 3, forming contact interfaces. Two contact interfaces are machined by rough milling and fine milling, with a roughness of 1.6 and a tolerance level of IT8. Acetone is used for cleaning and drying. The connecting heating ring 4 is configured to connect the pump body 8 to the fixed plate 3 and heat the pump body 8. A raised ring 81 is provided at a lower end of the pump body 8. The connecting heating ring 4 includes a first raised part 41. The first raised part 41 protrudes into the pump body 8. A recessed part 42 is provided outside the first raised part 41. The recessed part 42 is fitted with the raised ring 81. A second raised part 43 is provided outside the recessed part 42, and the second raised part 43 surrounds the outside of the raised ring 81. In order to keep the temperature of the pump body 8, a lightweight aerogel blanket is adhered to the side of the pump body 8 as a thermal insulation material.

As shown in FIG. 2, the stabilizing mechanism 5 is provided on the fixed plate 3 and located at a side of the connecting heating rings 4. The stabilizing mechanism 5 is configured to strengthen the stability of the pump body 8 and the fixed plate 3 after connection. The stabilizing mechanism 5 includes four mounting seats 51 provided at the side of the connecting heating rings 4. A first cylinder 52 is provided in the mounting seat 51. A protruding end of the first cylinder 52 is connected to a pressing block 53. The sensor 6 is provided on a lower end surface of the pressing block 53.

The sensor 6, which is a piezoelectric acceleration sensor, is provided at an end of the stabilizing mechanism 5 in contact with the pump body 8. The sensor 6 is configured to collect test data of the pump body 8 during the test.

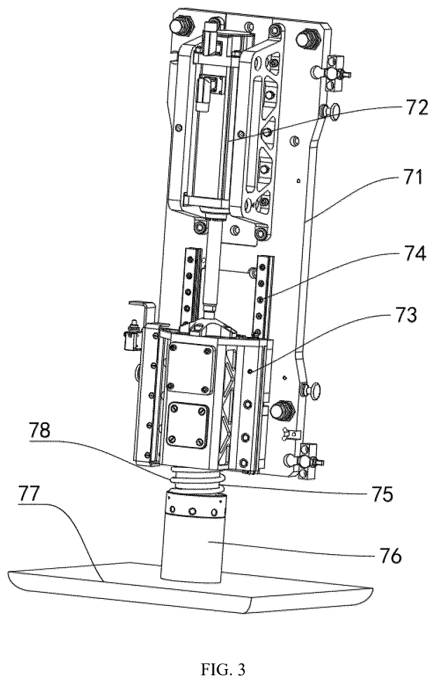

As shown in FIG. 3, the hammering mechanism 7 is provided on the fixed platform 1 and located at an upper end of the pump body 8. The hammering mechanism 7 is configured to excite the pump body 8 from top to bottom. The hammering mechanism 7 includes a mounting plate 71. A second cylinder 72 is fixedly connected to an upper end of the mounting plate 71. A protruding end of the second cylinder 72 is connected to a movable block 73. The mounting plate 71 is provided with a guide rail 74 located at a lower end of the second cylinder 72, and the guide rail 74 is in sliding connection with the movable block 73. A first guide rod 75 is provided in the movable block 73. The first guide rod 75 protrudes from a lower end of the movable block 73. A lower end of the first guide rod 75 is in sliding connection with a second guide rod 76. A lower end of the second guide rod 76 is connected to a hammering plate 77. The hammering plate 77 is made of nylon. A spring 78 surrounds the outside of the first guide rod 75. One end of the spring 78 is fixedly connected to the second guide rod 76, and the other end of the spring 78 is fixedly connected to the movable block 73. The hammering mechanism 7 causes the movable block 73 to move downwards by means of the second cylinder 72. The movable block 73 drives the hammering plate 77 to hammer the upper end surface of the pump body 8 through the first guide rod 75 and the second guide rod 76, so as to achieve an excitation effect. The spring 78 is configured to control the hammering force, so as not to cause damage to the pump body 8.

According to the testing method of the normal load testing device for a pump body, the specific steps are as follows. An internal threaded stud 82 of a pump body 8 is aligned with a through hole 44 of a connecting heating ring 4. A rotating mechanism 2 causes a fixed plate 3 to be rotated, such that a screw is penetrated through and screwed into the internal threaded stud 82 from the through hole 44 penetrating a lower end surface of the fixed plate 3 conveniently. After a preset tightening torque is applied to the screw, a connection form between the pump body 8 and an end cover is simulated. The rotating mechanism 2 causes the fixed plate 3 to rotate back to a horizontal state. The stabilizing mechanism 5 operates to strengthen the pump body 8 and brings a sensor 6 in close proximity to the pump body 8. A hammering mechanism 7 then hammers an upper end surface of the pump body 8. The sensor 6 collects an excitation frequency generated in the hammering process.

Further, according to this embodiment, under a same pre-tightening force of screws and a same hammering torque of hammering mechanisms 7, heating temperatures of the connecting heating rings 4 are controlled to be different for pump bodies 8, so as to measure the change of the normal loads of the pump bodies 8 at different temperatures.

Still further, according to this embodiment, under the same pre-tightening force of the screws and the same heating temperature of the connecting heating rings 4, hammering torques of the hammering mechanisms 7 are controlled to be different for the pump bodies 8, so as to measure the change of the normal loads of the pump bodies 8 under different hammering torques.

In this embodiment, several test temperatures can be set. The connecting heating ring 4 is energized to generate heat in sections, and each heating section is provided with a heat retaining temperature. Based on the sampling setting, the hammering mechanism 7 is configured to excite the pump body from top to bottom along the direction of the connecting line of the center of a screw hole, and effectively excites the pump body several times each time. The vibration mode and the vibration frequency in the x, y and z directions corresponding to the effective excitation are acquired at different temperatures through the sensor 6. The modal parameters such as the vibration mode and the inherent frequency of the test are obtained in a stable band.

After collecting the data, the measured contour values are saved as a data file with the extension of txt by Taylor-Hobson-120 profilometer and HT-SURF 10000 surface measurement and analysis system. The test data at various temperatures are selected using a sensitivity method. The frequency-response function program of the simulation joint is compiled using MATLAB. The characterization parameters of the generic interface (generic complexity and generic scale coefficients) at various test temperatures are identified using the frequency-response function method. Other preset parameters such as the test temperatures are substituted into an established theoretical model of the normal contact load/stiffness of the generic interface, to obtain an analytical solution of the normal load/stiffness at the preset screw tightening torque and temperature through calculation.

In the process of data calculation according to the present disclosure, the tightening torque can be converted into a value of the total normal load applied to the whole contact interface of the pump body through the mechanical design. That is, the normal contact load of the generic interface is engineering data already known. The parameters such as the thermal elastic-plastic normal contact load/stiffness of the generic interface of the pump body, expressions and functions, branching and cycling, repeating and copying functions, macro files, user subroutines and the like obtained by the above analytical method are defined by virtue of ABAQUS parametric design language, so as to complete the programming. Based on the analytical solution method of the established contact theoretical model of the generic interface and the finite element analysis method of related literatures, a fine finite element analysis model of the pump body is constructed by ABAQUS software. The analytical solution of the normal stiffness is embedded in the finite element analysis model of the pump body for optimization processing. The modal parameters such as the vibration mode and the inherent frequency identified at a certain temperature and a certain screw tightening torque are calculated, the accuracy of which is verified by the frequency-response function method. Based on the normal load value of the interface calculated by the engineering method, given several screw tightening torques, according to the principle of qualitative comparison of similarity of vibration modes, the vibration mode identified by the finite element method is compared with the vibration mode identified by the test. According to the principle of quantitative comparison of the inherent frequency, the inherent frequency identified by the finite element method is compared with the inherent frequency identified by the test, to calculate a relative error. If the error is less than a preset value, the pump body is calibrated according to the vibration mode and the inherent frequency currently identified; otherwise, the finite element analysis model is refined and optimized again, and the calculation is re-performed. Therefore, the above data analysis of the present disclosure can be used to determine the correction method of the established theoretical model and the quantification method of related parameters through the above manner, and then adjust the accuracy of the theoretical model to reduce the calculation error and improve the prediction precision.

To sum up, according to the present disclosure, an internal threaded stud of a pump body is aligned with a through hole of a connecting heating ring. A rotating mechanism causes a fixed plate to be rotated, such that a screw is penetrated through and screwed into the internal threaded stud from the through hole penetrating a lower end surface of the fixed plate conveniently. After a preset tightening torque is applied to the screw, a connection form between the pump body and the end cover is simulated. The connecting heating ring is then used to heat the inside and the outside of the pump body simultaneously, such that various temperature ranges required by the test can be conveniently obtained. Finally, the pump body is hammered from top to bottom by a hammering mechanism. The vibration mode and the vibration frequency formed due to hammering are acquired by the sensor. The modal parameters such as the vibration mode and the inherent frequency of the test are obtained in a stable band, and then are analyzed, so as to obtain the results of the normal load test. The normal load testing device can simulate the connection form between the pump body and the end cover, and can test a plurality of pump bodies at the same time, thus saving the test time.

What is claimed is:

1. A normal load testing device for a pump body, comprising a fixed platform (1), wherein a rotating mechanism (2) is provided on the fixed platform (1), a rotating end of the rotating mechanism (2) is connected to a fixed plate (3), and a plurality of internal threaded studs (82) are distributed circumferentially below the pump body (8); the normal load testing device further comprising:
a plurality of connecting heating rings (4), provided on the fixed plate (3), wherein the connecting heating ring (4) is provided with through holes (44) corresponding to the internal threaded studs (82), the through holes (44) penetrate through a lower end surface of the fixed plate (3), and the connecting heating ring (4) is configured to connect the pump body (8) to the fixed plate (3) and heat the pump body (8);
a stabilizing mechanism (5), provided on the fixed plate (3) and located at a side of the connecting heating rings (4), wherein the stabilizing mechanism (5) is configured to strengthen the stability of the pump body (8) and the fixed plate (3) after connection;
a sensor (6), provided at an end of the stabilizing mechanism (5) in contact with the pump body (8), wherein the sensor (6) is configured to collect test data of the pump body (8) during the test; and
a hammering mechanism (7), provided on the fixed platform (1) and located at an upper end of the pump body (8), wherein the hammering mechanism (7) is configured to excite the pump body (8) from top to bottom.

2. The normal load testing device for a pump body according to claim 1, wherein a raised ring (81) is provided at a lower end of the pump body (8); the connecting heating ring (4) comprises a first raised part (41) protruding into the pump body (8); a recessed part (42) is provided outside the first raised part (41) and is fitted with the raised ring (81); and a second raised part (43) is provided outside the recessed part (42), and surrounds the outside of the raised ring (81).

3. The normal load testing device for a pump body according to claim 1, wherein the rotating mechanism (2) comprises rotating seats (21) provided at both sides of the fixed platform (1) respectively, a rotating disc (22) is rotatably connected to an inner side of the rotating seat (21), a connecting block (23) is provided on the rotating disc (22), and the connecting block (23) is connected to the fixed plate (3).

4. The normal load testing device for a pump body according to claim 3, wherein a motor (24) is provided at an outer side of the rotating seat (21) at one side, an output end of the motor (24) is connected to the rotating disc (22) at the same side; an L-shaped block (25) is fixedly connected to an outer side of the rotating seat (21) at the other side, a slot (26) is provided in a horizontal part of the L-shaped block (25); the rotating disc (22) is connected to a rotating shaft (27) located below the L-shaped block (25), and the rotating shaft (27) is provided with a plurality of threaded holes (28).

5. The normal load testing device for a pump body according to claim 1, wherein the stabilizing mechanism (5) comprises a plurality of mounting seats (51) provided at the side of the connecting heating rings (4), a first cylinder (52) is provided in the mounting seat (51), a protruding end of the first cylinder (52) is connected to a pressing block (53), and the sensor (6) is provided on a lower end surface of the pressing block (53).

6. The normal load testing device for a pump body according to claim 1, wherein the hammering mechanism (7) comprises a mounting plate (71), a second cylinder (72) is fixedly connected to an upper end of the mounting plate (71), a protruding end of the second cylinder (72) is connected to a movable block (73), the mounting plate (71) is provided with a guide rail (74) located at a lower end of the second cylinder (72), and the guide rail (74) is in sliding connection with the movable block (73).

7. The normal load testing device for a pump body according to claim 6, wherein a first guide rod (75) is provided in the movable block (73), and protrudes from a lower end of the movable block (73); a lower end of the first guide rod (75) is in sliding connection with a second guide rod (76), and a lower end of the second guide rod (76) is connected to a hammering plate (77); a spring (78) surrounds the outside of the first guide rod (75), one end of the spring (78) is fixedly connected to the second guide rod (76), and the other end of the spring (78) is fixedly connected to the movable block (73).

8. A testing method of the normal load testing device for a pump body according to claim 1, wherein an internal threaded stud of the pump body is aligned with a through hole of a connecting heating ring, and a rotating mechanism causes a fixed plate to be rotated, such that a screw is penetrated through and screwed into the internal threaded stud from the through hole penetrating a lower end surface of the fixed plate conveniently, and after a preset tightening torque is applied to the screw, a connection form between the pump body and an end cover is simulated; the rotating mechanism causes the fixed plate to rotate back to a horizontal state, and the stabilizing mechanism operates to strengthen the pump body and brings a sensor in close proximity to the pump body; and a hammering mechanism then hammers an upper end surface of the pump body, and the sensor collects an excitation frequency generated in the hammering process.

9. The testing method of the normal load testing device for a pump body according to claim 8, wherein under a same pre-tightening force of screws and a same hammering torque of hammering mechanisms, heating temperatures of the connecting heating rings are controlled to be different for pump bodies, so as to measure the change of the normal loads of the pump bodies at different temperatures.

10. The testing method of the normal load testing device for a pump body according to claim 8, wherein under a same pre-tightening force of screws and a same heating temperature of the connecting heating rings, hammering mechanisms are controlled to apply different hammering torques to the pump bodies, so as to measure the change of the normal loads of the pump bodies under different hammering torques.
